(19) United States
(12) Patent Application Publication
(10) Pub. No.: US 2009/0071752 A1
(43) Pub. Date: Mar. 19, 2009

(54) OIL REMOVAL SYSTEM AND METHOD

(75) Inventors: Jason J. Raasch, Cedarburg, WI (US); Ray Matuszak, New Berlin, WI (US); Elliot Matel, Milwaukee, WI (US)

Correspondence Address: Michael Best & Friedrich LLP, 100 East Wisconsin Avenue, Suite 3300, Milwaukee, WI, 53202, US

(73) Assignee: BRIGGS & STRATTON CORPORATION, Wauwatosa, WI (US)

(21) Appl. No.: 11/856,164

(22) Filed: Sep. 17, 2007

(51) Int. Cl. F01M 11/04; F02N 11/00; F16N 33/00

(52) U.S. Cl. 184/1.5; 123/179.24; 222/1

(57) ABSTRACT

An apparatus for draining oil from an engine. The apparatus includes an engine having an engine housing, crankshaft, a piston, and an oil reservoir, an engine starting mechanism configured to engage the crankshaft and piston, a check valve configured to prevent pressure in a crankcase from escaping and configured to allow filtered air into the engine, and a selector valve configured to open a flow path between the check valve and a vent so oil can be drained.

### FIELD OF THE INVENTION

This invention relates to lubrication systems for an internal combustion engine. More specifically, the invention relates to an oil removal system and method for an engine.

### BACKGROUND OF THE INVENTION

In internal combustion engines, including engines used in a lawnmower, a snowblower, or other outdoor power equipment, the oil should be periodically drained and changed to maintain optimal engine performance. In these applications, the engine is typically mounted to a frame, such as a mower deck. When it is necessary to drain the engine oil, the oil is typically drained through a drain hole located near the bottom of the engine or tilting the equipment such that the oil can drain from the drain hole. Such methods require manipulation of sometimes heavy equipment and the use of gravity to drain the oil, and often result in spillage.

### SUMMARY

In one embodiment, the invention provides an apparatus for draining oil from an engine. The apparatus includes an engine having an engine housing, crankshaft, a piston, and an oil reservoir, an engine starting mechanism configured to engage the crankshaft, a check valve configured to prevent pressure in a crankcase from escaping and configured to allow filtered air into the engine, and a selector valve configured to open a flow path between the check valve and a vent so oil can be drained.

In another embodiment the invention provides a method for draining oil from an engine. The method includes moving a selector valve from a normal engine operation position to an oil drain position, activating an engine starting mechanism, opening a flow path between a check valve and a vent, and creating positive pressure to force oil from the engine.

Other aspects of the invention will become apparent by consideration of the detailed description and accompanying drawings.

### BRIEF DESCRIPTION OF THE DRAWINGS

FIG. 1 is a perspective view of a lawnmower having an embodiment of the present invention.

FIG. 2 is a schematic of an oil removal system embodying the present invention.

FIG. 3 is a perspective view of an engine housing having an oil drain hole.

FIG. 4 is another perspective view of a drilled passage for oil removal.

FIG. 5 is a side view of the drilled passage for oil removal.

FIG. 6 is a graphical illustration of oil evacuation time based on volume of oil.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

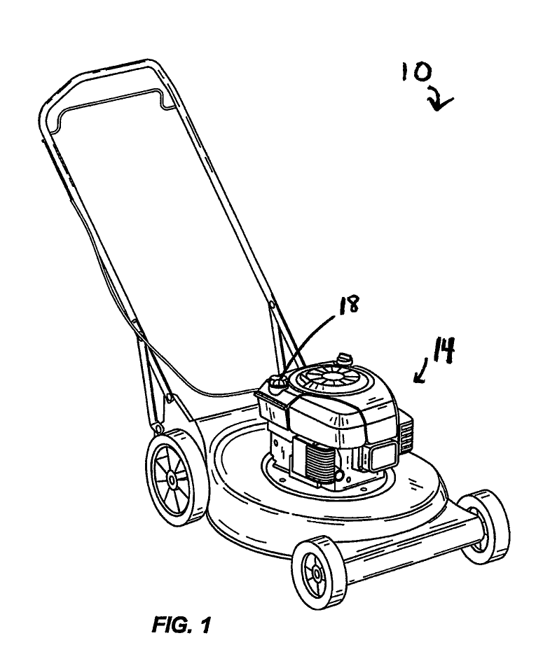

FIG. 1 illustrates a lawnmower 10 having an internal combustion engine 14 with a starting mechanism 18. The engine 14 is shown as powering a lawnmower, but the engine could be adapted for any situation in which a small engine is required. For example, the engine could be used to power other lawn and garden equipment, outdoor power equipment, augers, cultivators, a pump of a pressure washer or to power a generator. The starting mechanism 18 is shown as a recoil starter configured for manipulation by an equipment operator. However, the starting mechanism can be an electric starter or other type of starting mechanism.

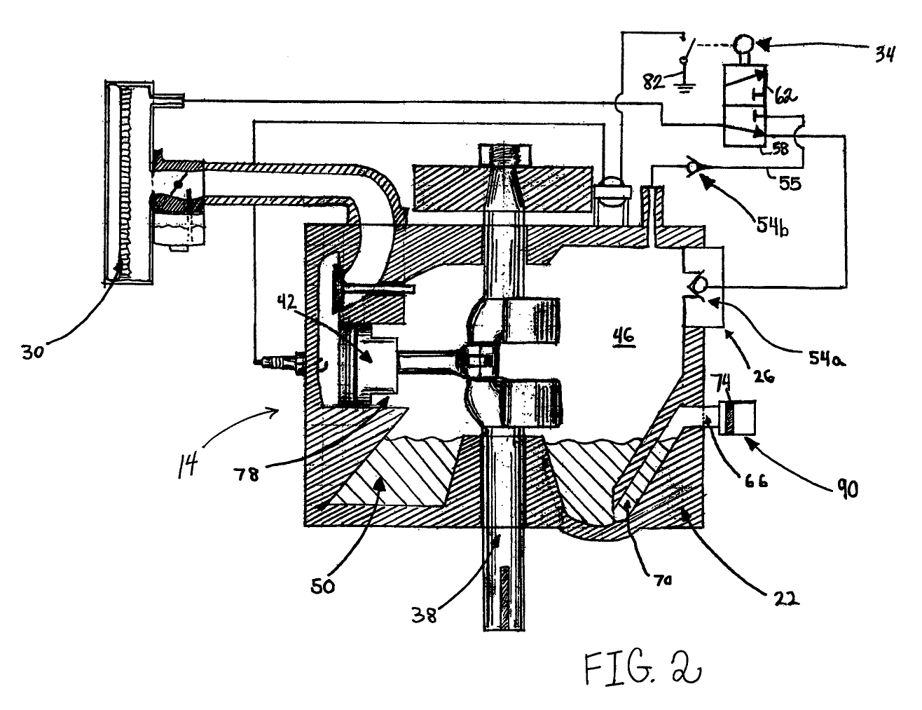

As illustrated in FIG. 2, the engine 14 includes an engine housing 22, a breather 26, an air cleaner 30, a selector valve 34, a crankshaft assembly 38, and a piston 42. The engine housing 22 is adapted to at least partially rotatably support a crankshaft assembly 38 in a crankcase 46. The engine housing 22 also includes an oil reservoir 50 to collect engine oil. Breather 26 includes a check valve 54a configured to vent the engine crankcase 46 to the engine air cleaner 30, while also preventing reverse oil flow, such that an oil mist will not escape the engine. During engine operation, the piston 42 is configured to slidingly reciprocate in the engine cylinder 78. The sliding motion of the piston 42 creates pressure within the engine 14 to enable combustion and control pressure-induced engine functions.

The selector valve 34 is configured for manipulation by an equipment operator. The selector valve has a first position 58 and a second position 62. The first position 58 corresponds to the normal engine operating condition, wherein the equipment operator uses the equipment. The second position 62 corresponds to an oil drain condition, during which the equipment operator drains the oil from the engine 14 according to the present invention. In the illustrated embodiment, the selector valve 34 is a single valve with two positions. However, in other embodiments, the selector valve may have a plurality of ports and a plurality of positions. Alternatively, the selector valve could include a first valve for the normal engine operation and a distinct second valve for oil drainage.

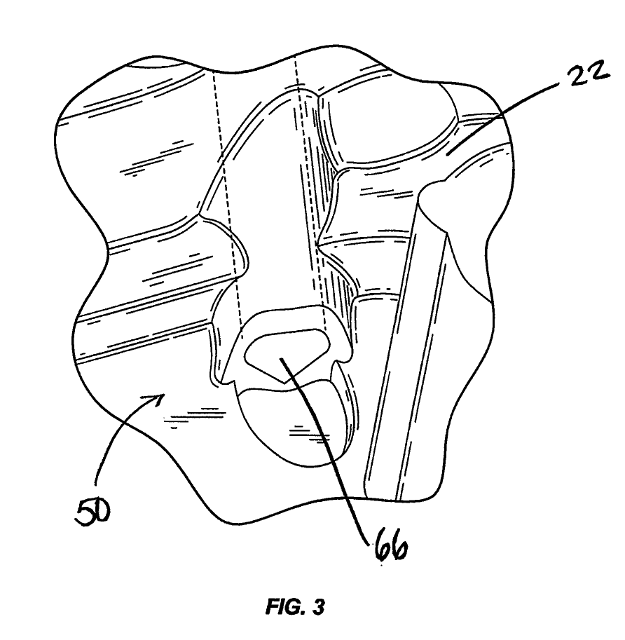

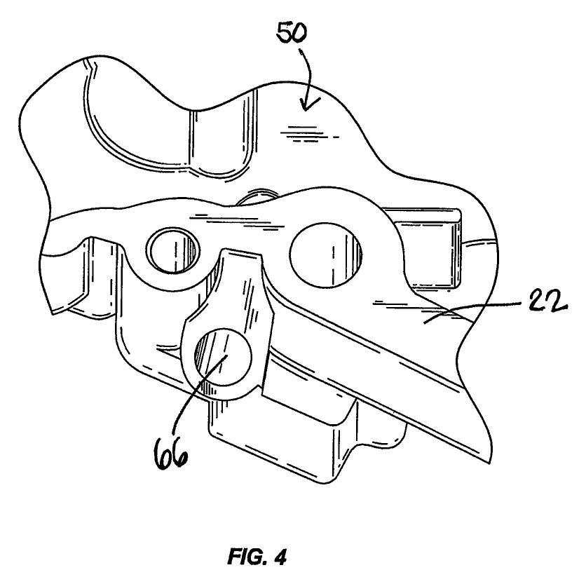

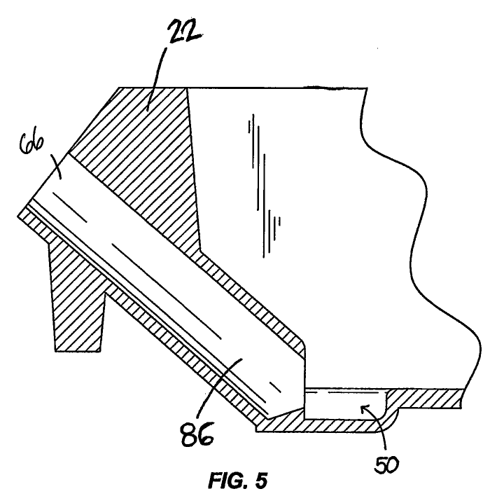

As illustrated in FIGS. 2-4, the engine housing 22 includes an oil port 66 configured for oil drainage. The oil port 66 is preferably a passage 70 formed through the lowest point of the engine housing 22 to permit maximum drainage. However, the oil port 66 can be a passage 70 formed at other locations in the engine housing 22 in which the passage 70 allows oil to drain. The oil port 66 can be drilled or formed by another type of manufacturing process. In some embodiments, a pick-up tube 86 (FIG. 5) can be utilized to allow oil drainage to the oil port 66 from the lowest points of the engine housing 22. The oil port 66 includes a shut-off valve 74 positioned on the exterior of the engine housing 22. The shut-off valve 74 closes the oil port 66 to prevent unwanted oil drainage when the selector valve 34 is in the first position 58.

In other embodiments, the oil port includes a quick-disconnect sleeve 90. The quick-disconnect sleeve 90 enables the equipment operator to attach a plastic tube or a plastic bag to the quick-disconnect sleeve to collect the oil for disposal. In some embodiments, the plastic bag includes a cover to close the oil drain hole of the plastic bag, thereby enabling the plastic bag to be used for multiple oil collections and drainages. In still other embodiments, the oil passage includes a spout or faucet for use with the quick-disconnect sleeve. The spout enables oil drainage and collection in a pan or other oil disposal receptacle.

Under standard engine operation, the selector valve 34 is in the first position 58. When the piston 42 travels downward in the cylinder 78 toward crankcase 46, the positive pressure is released because the breather 26 functions as a check valve 54a positioned to allow gas pressure to escape. The breather 26 also has a separator that reduces the amount of oil entrained in the vented crankcase gases.

To accomplish oil drainage from the engine 14, the engine 14 functions as a pump. More specifically, the engine starting mechanism 18 and piston 42 act in conjunction as a pump to pump out the oil, thereby eliminating the need for a separate pump to accomplish engine oil drainage. To drain oil from the engine 14, the selector valve 34 is moved to the second position 62 and engine ignition is prevented by either disconnecting the ignition wire(s) or grounding the ignition signals. In the second position 62, check valve 54b opens a unidirectional flow path 55 from the air filter 30 to engine crankcase 46, such that a positive pressure is built up in the crankcase 46 during oil drainage. The build-up of positive pressure forces oil out of the engine 14 through passages 70 or 86 and then through oil port 66. The selector valve 34 preferably includes an electrical ground switch 82 to ground the engine ignition while the selector valve 34 is in the second position 62 to prevent engine ignition while the engine oil is draining. With the selector valve 34 in the second position 62, oil drainage is initiated by manipulation of the starting mechanism 18. Pulling of the recoil starter or engaging the electric starter by the equipment operator causes positive pressure to build in the crankcase 46, forcing the oil out of the crankcase through the oil port 66.

The typical oil capacity of a small, single cylinder, internal combustion engine is about 16-20 ounces. In an engine with an oil capacity of 18 ounces, approximately five pulls on a manual recoil starter will force about 12-14 ounces of oil out of the engine housing the present invention. Approximately ten pulls will force the maximum amount of oil from the engine housing the present invention, whereby approximately three ounces of oil will remain in the engine housing following oil evacuation.

With the engine 14 and piston 42 operating as a pump, using the engine starting mechanism 18 provides a low-cost alternative to having a separate pump to drain the engine oil.

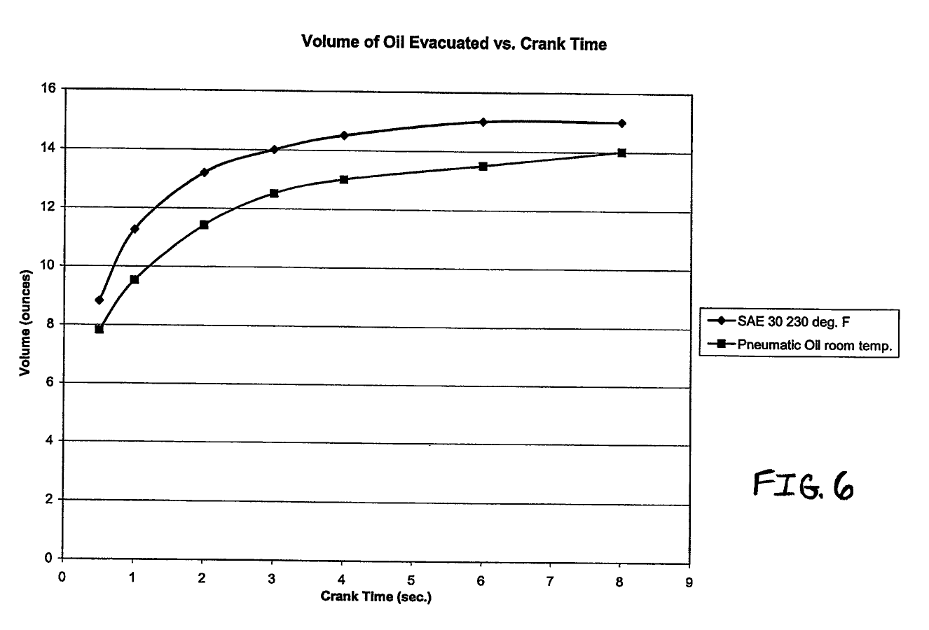

FIG. 6 graphically illustrates test data showing the volume of oil evacuated versus the crank time. The test samples included straight grade SAE 30 oil at 230 degrees Fahrenheit and control sample oil having the viscosity of hot oil, but which was tested at room temperature. FIG. 6 shows that the amount of oil evacuated from the oil reservoir levels off as the crank time increases. The pressure generated for oil drainage is high enough to accomplish oil drainage, yet low enough so as not to exceed the engine specifications (e.g., for the gaskets).

Various features and advantages of the invention are set forth in the following claims.

What is claimed is:

1. An apparatus for draining oil from an engine, the apparatus comprising:
an engine having an engine housing, crankshaft, a piston, and an oil reservoir;
an engine starting mechanism configured to engage the crankshaft;
a check valve configured to prevent pressure in a crankcase from escaping and configured to allow air into the engine; and
a selector valve configured to open a flow path between the check valve and a vent.

2. The apparatus of claim 1, wherein the engine starting mechanism is a recoil starter.

3. The apparatus of claim 1, further comprising an oil port in the engine housing configured to drain oil.

4. The apparatus of claim 3, wherein the engine housing further comprises a quick-disconnect connection coupled to the oil port and further configured to drain oil.

5. The apparatus of claim 3, wherein the oil port is formed in the lowest point of the engine housing.

6. The apparatus of claim 3, further comprising a pick-up tube coupled to the oil port and configured to evacuate oil from the engine housing.

7. The apparatus of claim 1, wherein the selector valve is a two-position valve, wherein a first position is a standard engine operation position and a second position is an oil drain position.

8. The apparatus of claim 1, wherein the selector valve is electrically connected to the engine ignition to ground engine ignition signals while the selector valve is in an oil drain position.

9. The apparatus of claim 3, further comprising a shut-off valve positioned adjacent the oil port.

10. The apparatus of claim 1, wherein the engine starting mechanism includes a recoil starter.

11. The apparatus of claim 1, wherein the engine starting mechanism includes an electric starter.

12. The apparatus of claim 1, wherein the selector valve includes a first valve for normal engine operation and a second valve for oil drainage.

13. A method for draining oil from an engine, the method comprising:
moving a selector valve from a normal engine operation position to an oil drain position;
activating an engine starting mechanism;
opening a flow path between a check valve and a vent; and
creating positive pressure to force oil from the engine.

14. The method of claim 13, further providing an oil port through the lowest point of an engine housing to promote oil drainage.

15. The method of claim 14, further comprising positioning a quick disconnect connection to drain oil from the oil port in the engine housing.

16. The method of claim 13, wherein moving the selector valve from the oil drain position to the normal engine operation position enables normal engine operation.

17. The method of claim 14, further comprising providing a shut-off valve on the engine housing.

18. The method of claim 13, further comprising providing the selector valve is electrically connected to the engine ignition to ground engine ignition signals while the selector valve is in the oil drain position.

19. The method of claim 14, further comprising providing a pick-up tube in the engine housing to evacuate oil from the engine housing to the oil port.

20. The method of claim 13, further providing the engine starting mechanism includes a recoil starter.

21. The method of claim 13, further providing the engine starting mechanism includes an electric starter.

22. The method of claim 13, further providing the selector valve is comprised of a first valve having an engine operation position and a second valve having an oil drain position.
